(19) United States
(12) Patent Application Publication
(10) Pub. No.: US 2007/0003903 A1
(43) Pub. Date: Jan. 4, 2007

(54) Color coded instruments

(76) Inventor: Dennis A. Meuchel, Missoula, MT (US)

Correspondence Address: JEAN KYLE, P. O. BOX 2274, HAMILTON, MT, 59840-4274, US

(21) Appl. No.: 11/478,826

(22) Filed: Jun. 30, 2006

Related U.S. Application Data
(60) Provisional application No. 60/695,343, filed on Jun. 30, 2005.

(51) Int. Cl. A61C 3/00

(52) U.S. Cl. 433/141

(57) ABSTRACT

A color coded instrument has a colored resin cone connected at one end of a handle to provide a means to visually identify the instrument. The working tip of the instrument extends from the cone. The cone provides a sanity, non-flexible, impermeable and sterile connection between the metal handle and working tip.

### REFERENCE TO RELATED APPLICATIONS

This application claims the benefits of U.S. Provisional Application No. 60/695,343, filed Jun. 30, 2005, the disclosure of which is hereby incorporated by reference in its entirety including all figures, tables and drawings.

### BACKGROUND OF THE INVENTION

Color coding systems are commonly applied to dental and medical instruments to prevent patient cross-contamination and to identify favored instruments for individual practitioners. Further, medical and dental instruments can be color coded to specify their use for a particular procedure. The dental industry, for many years, has used silicone rings (U.S. Pat. No. 4,988,295) or sleeves (U.S. Pat. No. 6,729,877 B2) to identify instruments. Silicone is flexible and the sleeves or rings are stretched over the metal handle to mark the instrument. The silicone markers do not adhere to the metal surface. Therefore, while the marked instrument is being used there is a chance that the marker will be moved allowing bacteria and pathogens to get under the sleeve or ring. Silicone is an excellent insulator and could shield these pathogens during subsequent sterilization processes presenting a potential health hazard. The chance that these silicone rings or sleeves may harbor bacteria and pathogens during sterilization has prompted attempts to find other means by which to color code instruments. The resin handles of some instruments are colored. Further, some instruments are color coded by electro-depositing a colored, water-borne polyurethane coating on their metal handles (U.S. Pat. No. 5,573,529).

A need remains however for a color coding system that effectively identifies an instrument, that is durable and yet will not harbor bacteria or pathogens during sterilization.

All patents, patent applications, provisional patent applications and publications referred to or cited herein, are incorporated by reference in their entirety to the extent they are not inconsistent with the explicit teachings of the specification.

### BRIEF SUMMARY OF THE INVENTION

A colored resin cone connected to the end of a metal handle provides a sanity, non-flexible indicator for instrument identification. The cone, from which the working tip of the instrument extends, can further be adhered to the metal handle. In a preferred embodiment, the cone is made from a thermosetting plastic which is adhered to the metal handle by induction heating adding a seamless visual marker to the instrument. Adhesives can be used to adhere the cone to the handle. The cone is an impermeable color marker on the instrument that does not harbor bacteria or other pathogens during sterilization.

### BRIEF DESCRIPTION OF THE DRAWINGS

FIG. 1 is a side view of a preferred embodiment of a color coded instrument of the subject invention.

FIG. 2 is a exploded partial side view of the instrument shown in FIG. 1.

FIG. 3 is a partial side view of the instrument shown in FIG. 1, a portion of the right end of the handle cut away to illustrate the shaft of the cone inserted into the handle.

FIG. 4 is a side view of another preferred embodiment of a color coded instrument of the subject invention.

FIG. 5 is a exploded partial side view of the instrument shown in FIG. 4, the pin of the handle and the cone shown in cross-section.

FIG. 6 is an exploded partial side view of another preferred embodiment of the color coded instrument of the subject invention, the cone and portions of the stem shown in cross-section.

### DETAILED DESCRIPTION OF THE INVENTION

The subject invention involves a hand held instrument that is color coded for easy identification. The colored element applied to the instrument is non-flexible and impermeable providing a sanitary, sterilizable marker for the instrument.

The subject invention is exemplified for use with dental hand instruments. It is important to note however that the subject color coding system and color coded instruments can be applied to any hand tools. The advantage of the exemplified system and instruments however is that they do not rely on flexible, insulative silicone that may harbor bacteria but provide a sanitary, sterilizable alternative for medical, veterinary and dental instruments.

Dental hand instruments typically have an elongated solid or tubular handles which support at least one working tip. The handles are made of stainless steel, chromed brass, or aluminum and have a round or octagonal cross section of from about 0.125 inches to about 0.375 inches in diameter. These handles are machined from bar stock by procedures well known in the art.

The working tips typically attached to these handles include, but are not limited to, those employed in periodontics, hygienics and diagnostics such as curettes, scalers, probes, and explorers; in operatives such as angle former, chisels, trimmers, excavators and carvers, and hatchet and hoe instruments; and in endodontics such as dryers and spreaders and pluggers. Working tips are usually stainless steel, carbon steel or other metals such as carbide steel.

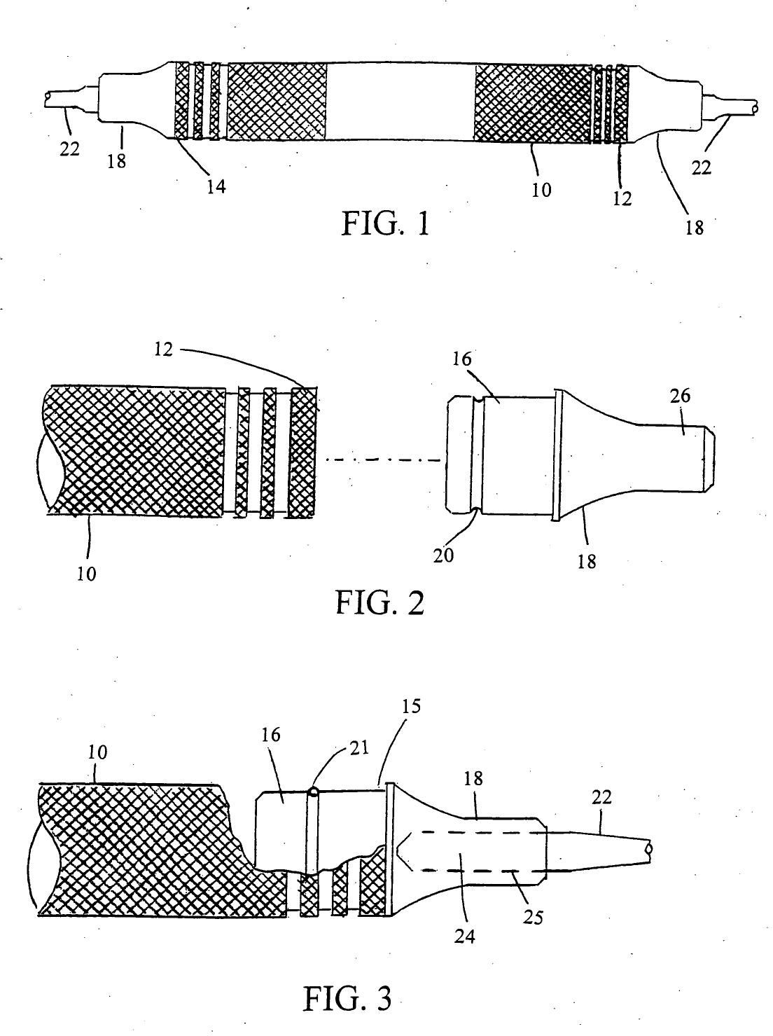

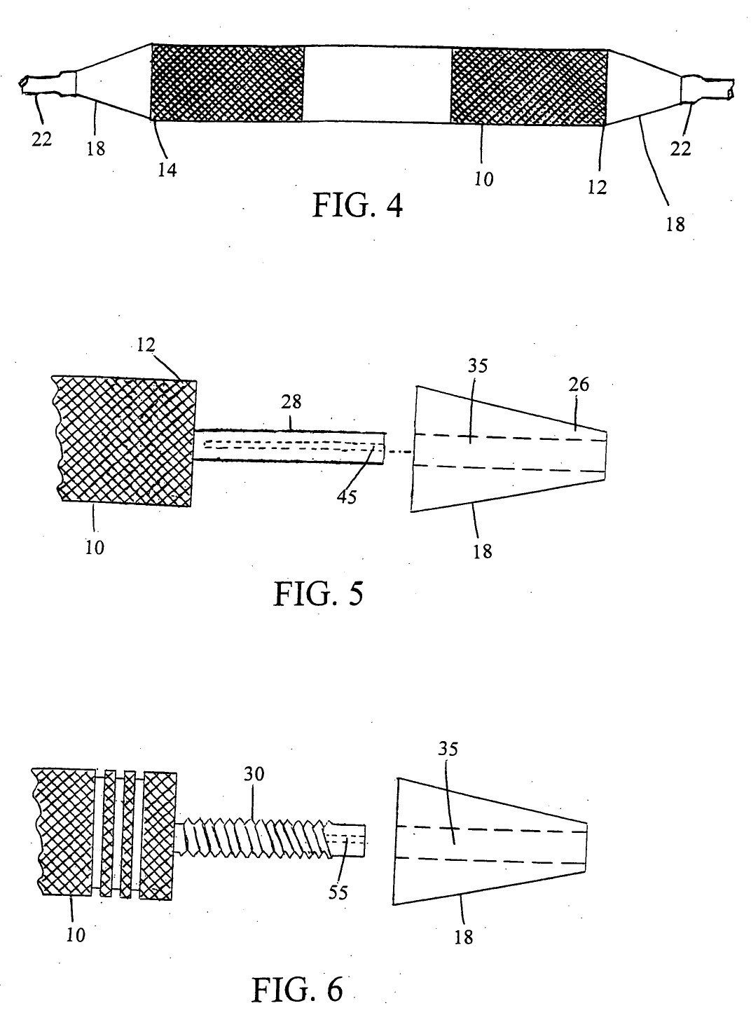

The invention involves connecting a colored resin cone to the end of a metal handle to provide a means to visually identify a particular instrument. A preferable embodiment of a color coded instrument according to the subject invention is shown in FIGS. 1-3. This embodiment shows the colored cone on a periodontic or operative type instrument. The cone shown in FIG. 1 has a tapered tip. The shape of the cone however can vary with application and intended use. For example, the tip of the cone on the instruments shown in FIGS. 4-6 do not taper and are applicable to endodontic type instruments.

The embodiments shown illustrate instruments with two working tips, one at either end of the elongated handle. It is important to note however that the instruments of the subject invention can have only a single working tip. Alternatively, the instruments can be configured to work with a multiple piece handle where the handle, cone, and working tip screw into a main body portion of an instrument to allow the practitioner to customize the instrument.

Referring to FIG. 1, the metal handle 10 is hollow and has one end 12 and another end 14. In this embodiment, each end of the handle has a bore 15 to receive the shaft end 16 of the colored resin cone 18. The shaft end 16 of the cone can be press-fitted into the bore 15 for assembly. It is generally known that in the press-fitting process, the relative sizes of the bore diameter and the shaft end diameter are such that there is a tight fit between the two, the bore diameter being slightly less than the shaft end diameter. As an example, forming each bore with a diameter of about 0.002 inches less than the diameter of the corresponding shaft end is sufficient. The shaft end can be press-fitted into the bore using a pneumatic, mechanical, or hydraulic press with appropriate controls to align the cone with the handle and to limit the depth of insertion of the shaft to a predetermined distance. Preferably, the shaft end 16 of the cone 18 has a groove 20 for mounting an O-ring 21. The O-ring 21 serves as a barrier to prevent debris and pathogens from entering the bore.

A working tip 22 is inserted into the tip 26 of the cone 18. The working tip 22 has a shank end 24 and a working end. In the drawings, the working ends are not shown because they can be of any configuration and are well know in the art. The working tip 22 can likewise be press-fitted into a bore 25 in the tip 26 of the resin cone 18 as shown in FIG. 1.

In a preferred embodiment, the cone 18 is adhered to the metal handle 12 and/or the working tip 22 is adhered to the cone 18. These parts can be adhered to one another by any suitable means. Preferably, with medical and dental hand instruments, the method of adhesion is impermeable or resistant to bacteria and able to be sterilized. Adhesives such as epoxies and metal epoxies can be used. In a particularly preferred embodiment however, the metal handle and/or working tip are adhered to the resin cone by a induction heating process described in U.S. Pat. No. 6,257,887 B1. The subject process relieves stress in the resin cone created by the press-fit process and provides a bond that does not allow joined pieces to rotate relative to one another. The metal element is provided with a non-slip surface, such as a knurl. As the knurled piece is fitted to the cone, the knurl scores the cone surface. Induction heating melts the resin to seal these score marks and penetrates the knurl recesses to, upon cooling, provide a strong adhesive bond that does not allow joint pieces to rotate. In this embodiment, the cone must be made of a suitable thermosetting plastic such as the sulfone polymers described in U.S. Pat. No. 6,257,877 B1 and below. It is noted that nearly every operation on the resin material such as machining, e.g. knurling or boring, molding, extruding, polishing, and threading creates a certain amount of internal stress in the material of the cone during manufacture. Therefore, treatment of the assembled instrument by heat induction with or without the metal element having a non-slip surface will create a durable and safe working instrument and avoid premature material fatigue, resultant cracking and failure.

The cone is preferably made of a medical grade resin. Sulfone polymers have been found to be especially suitable for the cone of the subject invention and, as noted above, are appropriate for induction heating. Sulfone polymers are amorphous thermosetting thermoplasitcs. In particular, polyphenylsuflone formulated by Amoco Performance Products, Inc. under the brand name RADEL R has been found to be especially suitable. Other suitable sulfone polymers are polyethersulfone formulated by Amoco Performance Products, Inc. under the brand name RADEL A, and polysulfone formulated by Amoco Performance Products, Inc. under the brand name UDEL. These sulfone polymers, and particularly RADEL R polyphenylsulfone, are high temperature thermosetting polymers that exhibit good thermal stability, toughness, chemical resistance, and stress cracking resistance. They are suitable for use in instruments that are to be sterilized by steam autoclaving, or harsh disinfecting chemicals.

The cone is fabricated by various methods such as by injection molding or by machining from rod stock. The colors of the resin cone can be any color that will clearly visually identify that instrument during a dental procedure, such as red, blue, green, yellow, purple, orange, white and black.

Another preferred embodiment of the color coded instrument of the subject invention is shown in FIGS. 4 and 5. In this embodiment, the metal handle 10 is solid and has pins 28 which are inserted into the cone 18. The cone 18 has a bore 35 which receives the pin 28. Preferably, the pin and bore are of a diameter that allows them to be assembled by press-fitting. In a particularly preferred embodiment, the pin 28 has a non-slip surface and upon assembly the handles and cone are heat treated as described above. In this embodiment, the pin 28 extends through to the tip 26 of the cone 18. The working tip 22 is therefore inserted directly into a bore 45 in the metal handle 10. Several endodontic procedures require the working tip of the instrument to be heated. In this embodiment, advantageously excess heat from the tip is dissipated by the metal handle and does not effect the resin cone. It is noted, however, that a shorter pin 28 that does not extend to the tip 26 of the cone could be used to mount the cone on the handle. A bore at the tip of the cone would therefore be present to receive the shank of the working tip.

Another preferred embodiment of the color coded instrument of the subject invention is shown in FIG. 6. In this embodiment, the cone 18 is screwed onto a threaded stem 30 of the metal handle 10. The cone can be machined to have corresponding threads. The stem extends to the tip of the cone. A bore 55 in the end of the stem receives the shank of the working tip 22. This embodiment, likewise, provides the advantage of being able to have its working tip heated without effecting the resin cone.

It is understood that the foregoing examples are merely illustrative of the present invention. Certain modifications of the articles and/or methods employed may be made and still achieve the objectives of the invention. Such modifications are contemplated as within the scope of the claimed invention.

1. A color coded instrument comprising:
a metal handle comprising one end and another end;
a colored resin cone connected to at least one end of the handle; and
a working tip extending from the colored resin cone; wherein the colored resin cone provides a means to visually identify the instrument and will not harbor pathogens.

2. The color coded instrument of claim 1, wherein said instrument is heat treated by induction heating.

3. The color coded instrument of claim 1, wherein said colored resin cone is adhered to said metal handle.

4. The color coded instrument of claim 1, wherein said colored resin cone is adhered to said metal handle with an adhesive.

5. The color coded instrument of claim 1, wherein said colored resin cone is adhered to said metal handle by induction heating.

6. The color coded instrument of claim 1, wherein said working tip is adhered to said colored resin cone.

7. The color coded instrument of claim 1, further comprising a non-slip surface on said metal handle where said metal handle is connected to said resin cone and wherein said instrument is heat treated by induction heating.

8. The color coded instrument of claim 6, wherein said working tip has a shank end that extends from said resin cone and further comprises a non-slip surface on said shank end, and wherein said instrument is heat treated by induction heating.

9. The color coded instrument of claim 1, wherein said metal handle is selected from a group consisting of, stainless steel, chromed brass and aluminum.

10. The color coded instrument of claim 1, wherein said colored resin cone is connected to said metal handle when at least one bore in at least one end of said handle receives a shaft of said resin cone.

11. The color coded instrument of claim 1, wherein said colored resin cone is connected to said metal handle when at least one pin on at least one end of said handle is received by a bore in said resin cone.

12. The colored coded instrument of claim 11, wherein said pin is a threaded stem.

13. The color coded instrument of claim 11, wherein said pin extends to a tip of said cone and said working tip is connected to said pin.

14. A color coded instrument comprising:
a metal handle comprising one end and another end and comprising at least one bore in at least one end;
a colored resin cone comprising a shaft and a tip, connected to at least one end of the handle when the shaft of the cone is received by the bore of the metal handle; and
a working tip connected to and extending from the colored resin cone; wherein the colored resin cone provides a means to visually identify the instrument and will not harbor pathogens.

15. The color coded instrument of claim 14, wherein said instrument is heat treated by induction heating.

16. The color coded instrument of claim 14, wherein said working tip has a shank end that extends from said resin cone and further comprises a non-slip surface on said shank end, and wherein said instrument is heat treated by induction heating.

17. A color coded instrument comprising:
a metal handle comprising one end and another end and comprising at least one pin on at least one end;
a colored resin cone comprising a bore, connected to at least one end of the handle when the pin of the handle is received by the bore of the cone; and
a working tip extending from the colored resin cone; wherein the colored resin cone provides a means to visually identify the instrument and will not harbor pathogens.

18. The color coded instrument of claim 16, wherein said instrument is heat treated by induction heating.

19. The color coded instrument of claim 16, wherein said pin is a threaded stem.

20. The color coded instrument of claim 14, further comprising a non-slip surface on said metal handle where said metal handle is connected to said resin cone, and wherein said instrument is heat treated by induction heating.
